(19) United States
(12) Patent Application Publication
(10) Pub. No.: US 2006/0012097 A1
(43) Pub. Date: Jan. 19, 2006

(54) Cutting board and receptacle assembly

(76) Inventor: Jerry D. Wernette, Racine, WI (US)

Correspondence Address: JANSSON, SHUPE & MUNGER & ANTARAMIAN, LTD, 245 MAIN STREET, RACINE, WI, 53403, US

(21) Appl. No.: 10/892,331

(22) Filed: Jul. 15, 2004

(51) Int. Cl. B23Q 3/00

(52) U.S. Cl. 269/289 R

(57) ABSTRACT

A cutting board and receptacle assembly for use during material processing, such as food preparation, above a work surface are described. The assembly includes a rigid platform having a processing surface, a stand for holding the platform above the work surface at a height allowing a container resting on the work surface to be positioned below the platform to receive processed material such as prepared food, and a receptacle frame connected with respect to platform and/or stand, the receptacle frame supporting a receptacle for receiving waste, the receptacle having an opening which is substantially vertical when the receptacle is supported by the receptacle frame.

### FIELD OF THE INVENTION

The invention relates generally to material processing, and, more particularly, to tools for facilitating such material processing.

### BACKGROUND OF THE INVENTION

It is often necessary when preparing food to chop, dice, slice, peel, scale, or otherwise prepare the ingredients before introducing them to the cooking vessel or measuring cup. This chopping can be accomplished using various devices, the most common of which is a cutting board and knife. Typically, once the food has been prepared, it is transferred to the cooking vessel or to a measuring cup by lifting the board and its contents to its destination and scraping the food off of the board with a knife blade or other utensil.

This procedure is adequate when the quantity of chopped or sliced food is small and uniform. However, attempts to scrape the various different prepared foods into a conventional measuring cup or a cooking vessel with a relatively small opening often result in a considerable quantity of the food falling to the stove top, counter or floor. It would be a benefit, therefore, if the processing surface were flush with or above the opening of the food container, thus allowing the prepared food to be easily moved from the processing surface to the container without the need to lift and carry the entire cutting board. In addition, it would be a benefit, if multiple foods could be prepared on a processing surface without having to move the entire cutting board to dispose of one of the prepared foods.

In addition, it would be a benefit to provide such an assembly with a variety of different processing surfaces so that different food processing methods can be performed. A kit including a plurality of such processing surfaces and a stand and receptacle frame would be an important advance in the field of food preparation.

Furthermore, when performing a food processing method, such as peeling or scaling, the waste generated is often scattered beyond the edges of the cutting board. Therefore, a device which reduces or eliminates such scattering would be an important advance.

An improved cutting board and receptacle assembly which addresses the problems of known cutting boards would be an important advance in the art. The present invention is directed to a cutting board and receptacle assembly and kit which overcomes the disadvantages of the aforementioned prior art.

### OBJECTS OF THE INVENTION

It is an object of the invention to provide a cutting board and receptacle assembly which overcomes some of the problems and shortcomings of the prior art.

Another object of the invention is to provide a cutting board and receptacle assembly which facilitates use and clean up.

Another object of the invention is to provide a cutting board and receptacle assembly which allows for one or more containers to be positioned under the processing surface.

Another object of the invention is to provide a cutting board and receptacle assembly which positions a waste receptacle adjacent to the processing surface to receive waste therefrom.

Another object of the invention is to provide a cutting board and receptacle assembly which positions the opening of a waste receptacle substantially vertical.

Another object of the invention is to provide a cutting board and receptacle assembly which includes a plurality of different platforms to provide different processing surfaces necessary in different food processing methods.

Another object is to provide a convenient way to dispose of food wrappings, packaging, and table scraps.

Still another object of the invention is to provide a kit including a plurality of platforms having different processing surfaces, a stand, and a receptacle frame.

Yet another object of the invention is to provide a cutting board and receptacle assembly suited for use with industry standard waste bags.

How these and other objects are accomplished will become apparent from the following descriptions and the drawings.

### SUMMARY OF THE INVENTION

This invention is an improved cutting board and receptacle assembly for facilitating the processing of materials, and in particular to the preparation of food or other applications where cutting, separating, and collecting of parts are required, such as in medical or scientific dissections. The invention represents a significant advance over the state of the art by providing novel elements to satisfy the objectives herein.

In certain embodiments, the cutting board and receptacle assembly comprises a rigid platform having a processing surface; a stand for holding the platform above the work surface at a height allowing a container resting on the work surface to be positioned below the platform to receive processed material; and a receptacle frame connected with respect to the platform and/or stand, the receptacle frame supporting a receptacle for receiving waste, the receptacle having an opening which is substantially vertical when the receptacle is supported by the receptacle frame.

In some embodiments, the stand is adjustable to allow the platform to be held at an adjustable angle with respect to the work surface.

In some embodiments, the stand includes legs having anti-slip surfaces for contact with the work surface.

In some embodiments, the platform is bounded by edges, the platform including at least one channel adjacent the processing surface and extending to an edge to allow liquid to drain from the platform.

In some embodiments, the platform includes at least one aperture, the aperture receiving a portion of the receptacle frame to hold the receptacle frame at a fixed position with respect to the platform.

In some embodiments, the receptacle frame includes two arms, each arm terminating at an end, each end received within and supported by the platform.

In some embodiments, the receptacle frame includes a pivot separating a first portion from a second portion, the first portion being pivotable about the pivot with respect to the platform.

In some embodiments, the platform and stand are unitary.

In some embodiments, the assembly further comprises connection means for connecting the platform and stand. Such connection means may be a pin-and-aperture arrangement which allows connection and disconnection between the platform and stand.

In some embodiments, the receptacle is a flexible bag which rests on the work surface when the opening is supported by the receptacle frame. Such a bag may be a standard commercially available bag or it may be specifically designed for use with the receptacle frame.

In some embodiments, the stand or platform includes at least one aperture which receives a portion of the receptacle frame to hold the receptacle frame at a fixed position with respect to the stand or platform.

In some embodiments, the platform includes a lower portion and the stand includes raised guide-members, the lower portion fitting within the guide-members. In such embodiments, the platform may include an upper portion which is positioned above the guide-members when the lower portion is received within the guide-members.

The invention may also be described as a cutting board and receptacle assembly for use during material processing above a work surface, in which the assembly comprises a rigid platform having a processing surface; a stand for holding the platform above the work surface at a height allowing a container resting on the work surface to be positioned below the platform to receive prepared material, the platform attachable to and removable from the stand; and a receptacle frame connected with respect to the platform and/or stand for supporting a bag having an opening for receiving waste such that the opening is substantially vertical when the bag is supported by the receptacle frame and accepts waste from the processing surface, the opening surrounding the frame and the platform.

The invention may also be described as a kit for use during material processing, particularly food preparation, above a work surface. Such kit comprises a plurality of platforms having processing surfaces; a stand for holding one platform at a time above the work surface at a height allowing a container to be positioned on the work surface below the platform to receive processed material; and a receptacle frame connected with respect to the platform and/or stand, the receptacle frame supporting a receptacle for receiving waste, the receptacle having an opening which is substantially vertical when the receptacle is supported by the receptacle frame.

In some embodiments, the plurality of platforms includes identical means for connection to the stand such that the platforms are interchangeable.

In some embodiments, each of the plurality of platforms includes first and second edges and apertures spaced from the first and second edges such that each of the plurality of platforms may be connected to the stand regardless of orientation.

In some embodiments, the plurality of platforms comprises a platform including only a flat cutting surface; a platform including a grater; a platform including a slicer; a platform including a grid cutter; a platform including a fish scaling and cleaning surface; or a platform including a combination of at least two of a flat cutting surface, a grater, a slicer, a grid cutter, and a fish scaling and cleaning surface.

In some embodiments, the stand includes means for mounting the receptacle frame.

### BRIEF DESCRIPTION OF THE DRAWINGS

FIG. 1 is a perspective view of an embodiment of the cutting board and receptacle assembly in accordance with the principles of the present invention.

FIG. 2 is a perspective view of an embodiment of the cutting board and receptacle assembly of FIG. 1 showing an alternate mounting for the receptacle frame.

FIG. 3 is an overhead view of an embodiment of the stand of the cutting board and receptacle assembly in accordance with the principles of the present invention.

FIG. 4 is a front view of the stand and platform of FIG. 3.

FIG. 5 is a side view of the stand of FIGS. 3 and 4.

FIG. 6 is an overhead view of another embodiment of the stand of the cutting board and receptacle assembly in accordance with the principles of the present invention.

FIG. 7 is a front view of the stand and platform of FIG. 6.

FIG. 8 is a side view of the stand of FIGS. 6 and 7.

FIG. 9 is an overhead view of another embodiment of the stand of the cutting board and receptacle assembly in accordance with the principles of the present invention.

FIG. 10 is a front view of the stand and platform of FIG. 9.

FIG. 11 is a side view of the stand and platform of FIGS. 9 and 10.

FIG. 12 is an overhead view of another embodiment of the stand of the cutting board and receptacle assembly in accordance with the principles of the present invention.

FIG. 13 is a front view of the stand and platform of FIG. 12.

FIG. 14 is a side view of the stand of FIGS. 9 and 10.

FIG. 15 is an overhead view of an alternate platform in accordance with the principles of the present invention.

FIG. 16 is a front view of an alternate platform in accordance with the principles of the present invention.

FIG. 17 is a front view of an alternate platform in accordance with the principles of the present invention.

FIG. 18 is an overhead view of a plurality of platforms in accordance with the principles of the present invention.

FIG. 19 is a side view of an assembly in accordance with the principles of the present invention.

FIG. 20 is a side view of an assembly in accordance with the principles of the present invention.

FIGS. 21 and 22 are front views of alternate receptacle frames in accordance with the principles of the present invention.

FIG. 23 is a side view of two alternate receptacle frames in accordance with the principles of the present invention.

FIG. 24 includes data showing the location of peeled waste portions from a potato and a carrot to demonstrate the need for the current invention.

### DETAILED DESCRIPTION OF PREFERRED EMBODIMENTS

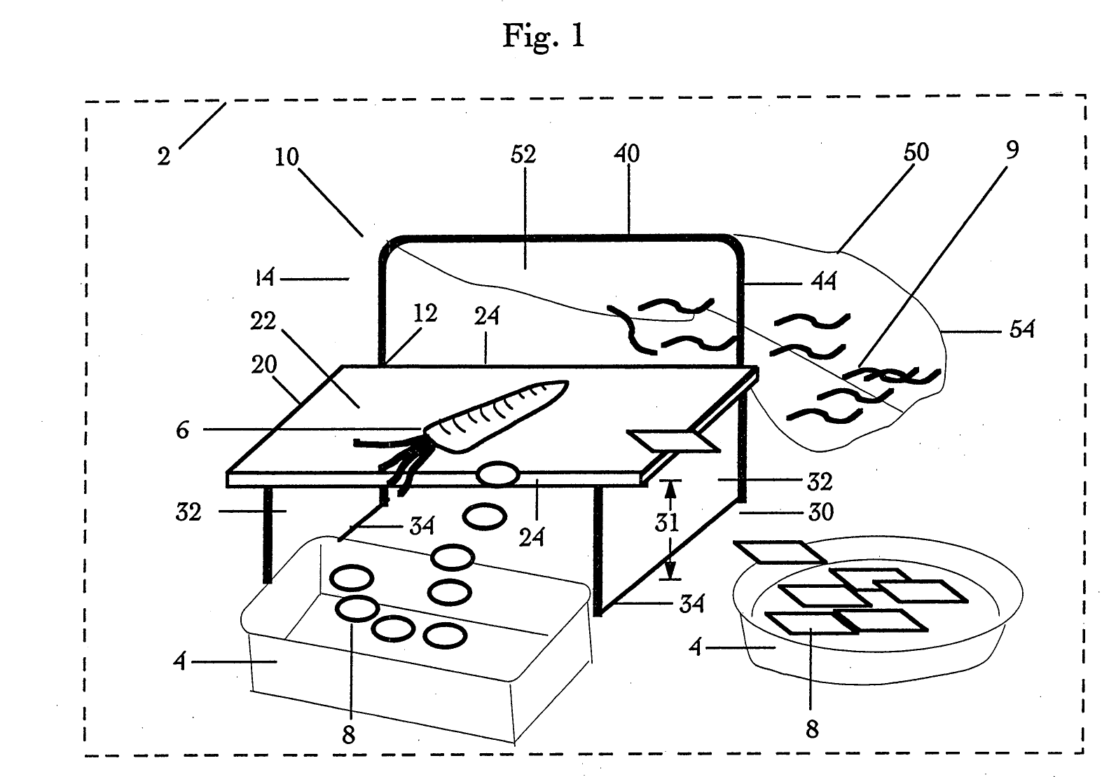

FIG. 1 is a perspective view of an embodiment of the cutting board and receptacle assembly 10 in accordance with the principles of the present invention. Assembly 10 includes a platform 20, a stand 30, and a receptacle frame 40.

Platform 20 includes a processing surface 22 which extends between edges 24 and beyond stand 30 to the left, right, and front, thereby allowing the user to slide the processed material, such as prepared food, 8 to the left, right, or front off of processing surface 22 into a container 4. Platform 20 may be metal, plastic, wood, or any other known type. Legs 32 support platform 20 over work surface 2 at a height 31 such that container 4 may be positioned below platform 20 to receive processed material 8. Legs 32 preferably have anti-slip surfaces 34 which may be rubber or another known material having sufficient friction to serve as an anti-slip surface. Legs 32 may be foldable or removable to facilitate storage and may be adjustable to allow for control of the angle of the processing surface 22. In certain embodiments, the legs may be telescopically adjustable. Platform 20 or stand 30 may optionally support a knife sharpener or the like.

Receptacle frame 40 is shown as a U-shaped member having two arms 44. Arms 44 are connected to either platform 20 or stand 30 via frame mounting means 12 at a fixed substantially vertical position. Receptacle 50, which is shown as a flexible bag 54 resting on work surface 2, includes an opening 52 which is supported by frame 40. Opening 52 is, thus, substantially vertical and allows waste 9 to be deposited directly into receptacle 50 from processing surface 22 or above where cutting, slicing, peeling, scaling, or the like are performed.

Also shown in FIG. 1 is a second container 4 which can also be positioned under platform 20 to receive processed material 8 which is separated from the processed material 8 received in the other container 4.

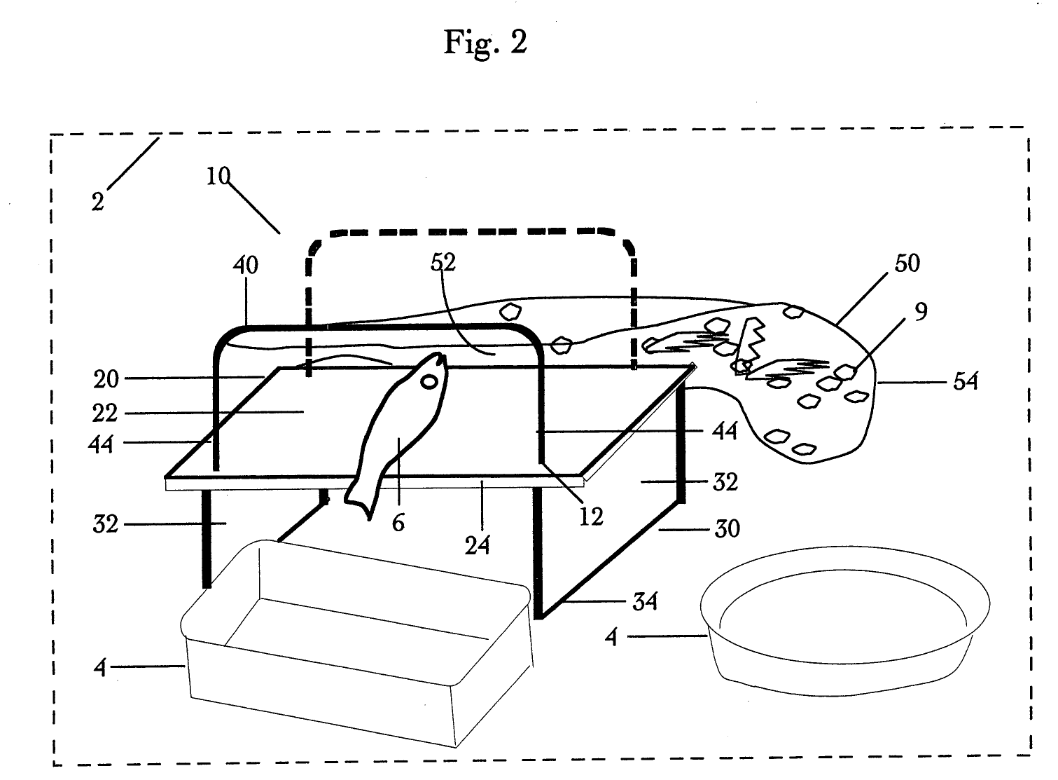

FIG. 2 is a perspective view of the assembly 10 of FIG. 1 showing an alternate mounting position for the receptacle frame 40. As shown receptacle frame 40 is connected to platform 20 near its front edge 24 (all references to front, rear, side, etc. herein are only in reference to the orientations shown and are not intended to be limiting) rather than at its rear edge 24 as shown in dashed lines and in FIG. 1. Mounting at the front of platform 20 allows a user to more easily contain otherwise messy material processing or food preparation procedures, such as scaling a fish. As shown, the material 6 to be processed, i.e., the fish, is substantially bounded by platform 20 and receptacle 50 such that little or no waste 9 is littered about the work surface 2.

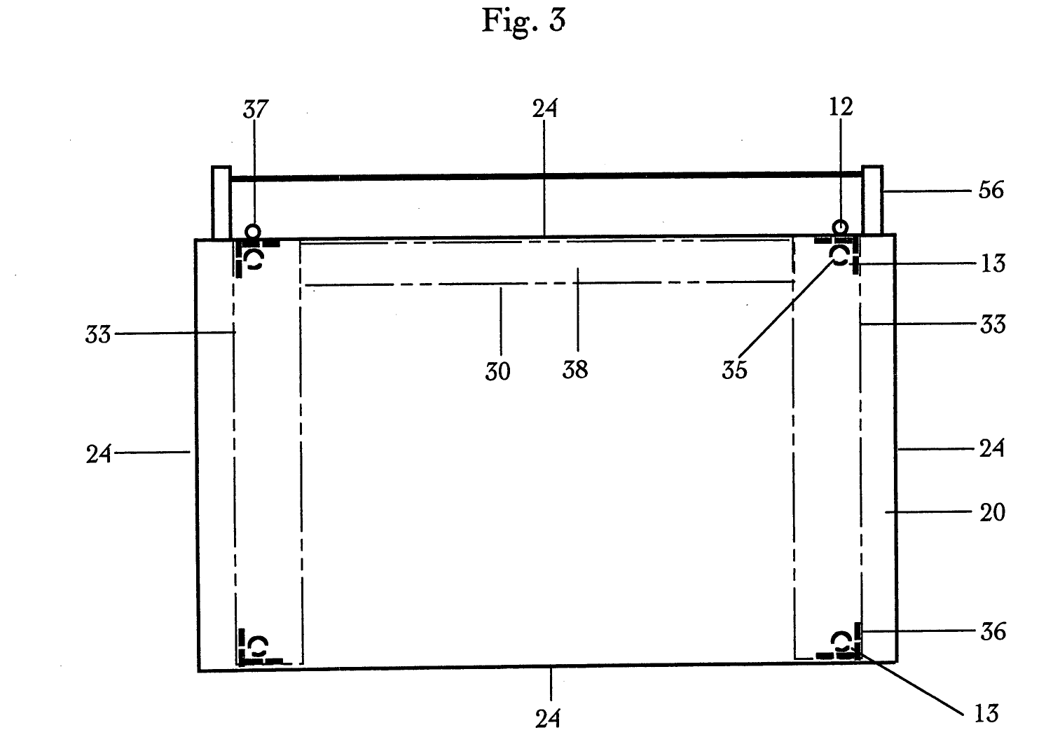

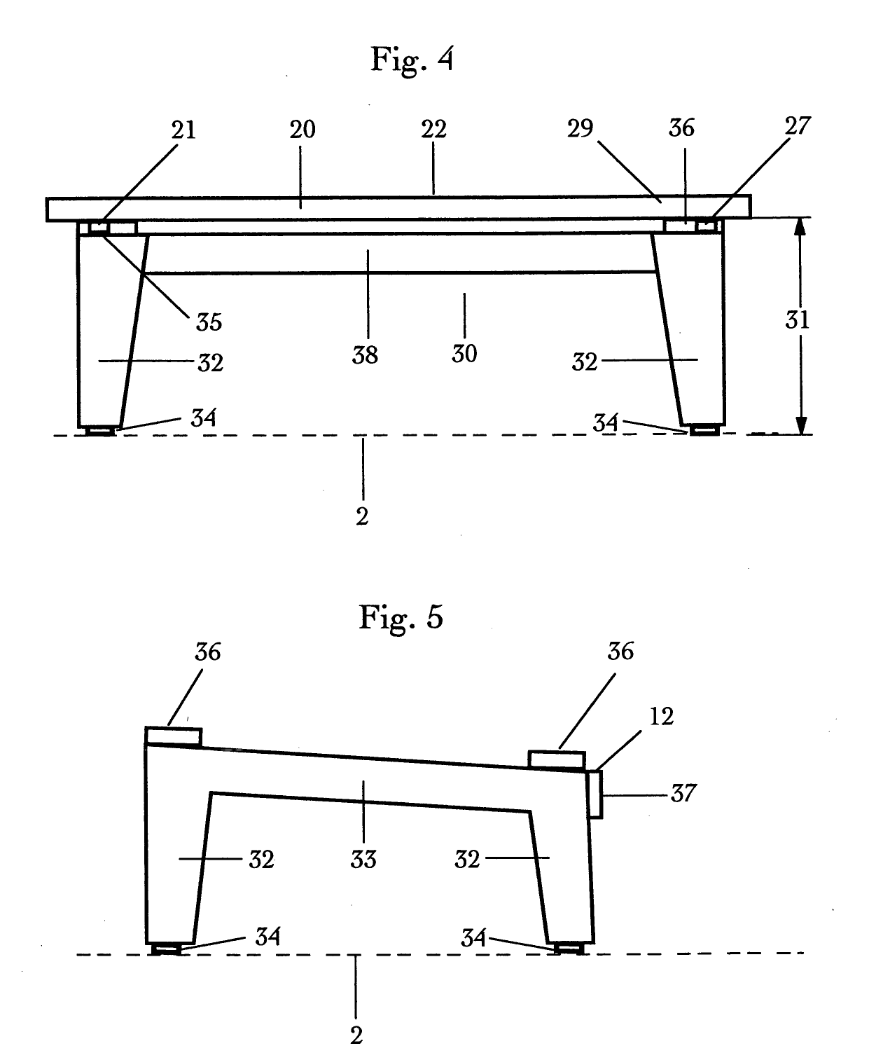

FIG. 3 is an overhead view of an embodiment of stand 30 of the cutting board and receptacle assembly 10. Stand 30 includes web members 33 which support legs 32 (not shown) and are interconnected by lateral web member 38. Stand 30 includes connection means 13 which are shown as bores 35 which receive posts 21 (shown in FIG. 4) to connect to platform 20. Stand 30 also includes raised guide-members 36 which are shown as L-shaped members located at the corners of stand 30. Guide-members 36 can receive a lower portion of platform 20 or posts 21.

Stand 30 includes mounting means 12 for mounting receptacle frame 40. Mounting means 12 are shown as open sleeves 37 which receive the ends of frame 40, though such sleeves 37 may be closed. Also depicted is a bag roll holder 56 which may be fixed to stand 30 to hold additional bags for use.

FIG. 4 is a front view of the platform 20 and stand 30 of FIG. 3. Stand 30 supports platform 20 at a height 31 above work surface 2. Stand 30 includes legs 32 which have anti-slip surfaces 34 for contact with work surface 2. Lateral web member 38 connects the rear legs or rear portions of legs 32. Raised-guide members 36 are shown receiving lower portion 27 of platform 20 which, in this embodiment, are posts 21 received in bore 35. Alternatively, platform 20 may include holes which also receive posts 21. Upper portion 29 of platform 20 is not received within guide-members 36 and extends beyond the profile of stand 30.

FIG. 5 is a side view of the stand 30 of FIGS. 3 and 4. As shown, rear legs 32 are shorter than front legs 32 to allow a platform positioned on stand 30 to drain to the rear, into receptacle 50. Web members 33 interconnect front and rear legs 32. Frame mounting means 12 are shown at the rear of stand 30. Bag roll holder 56 is not shown in this Figure.

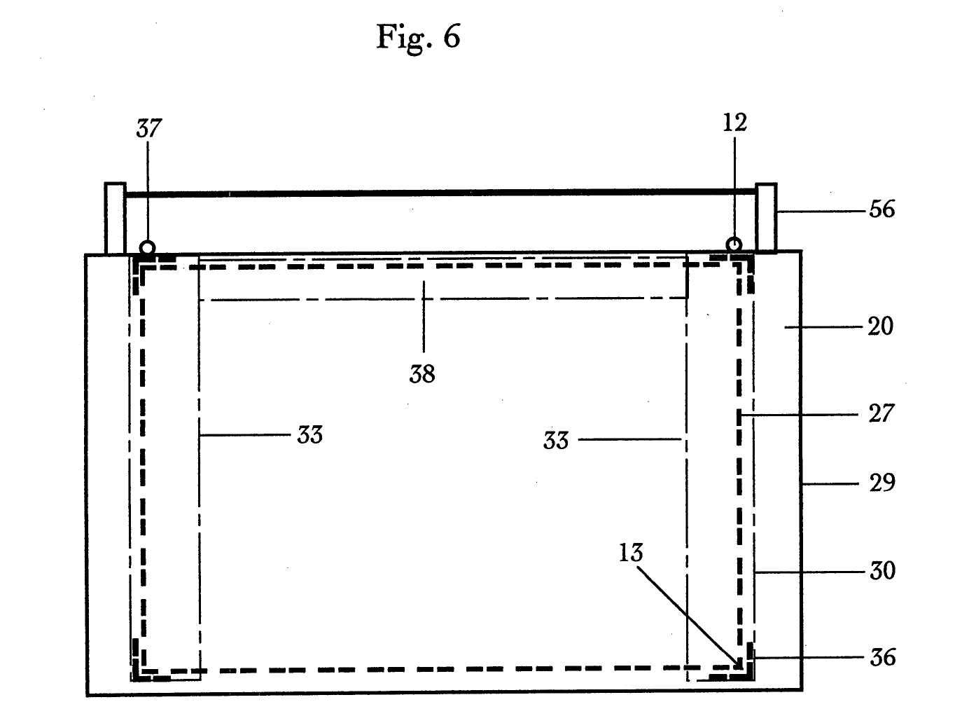

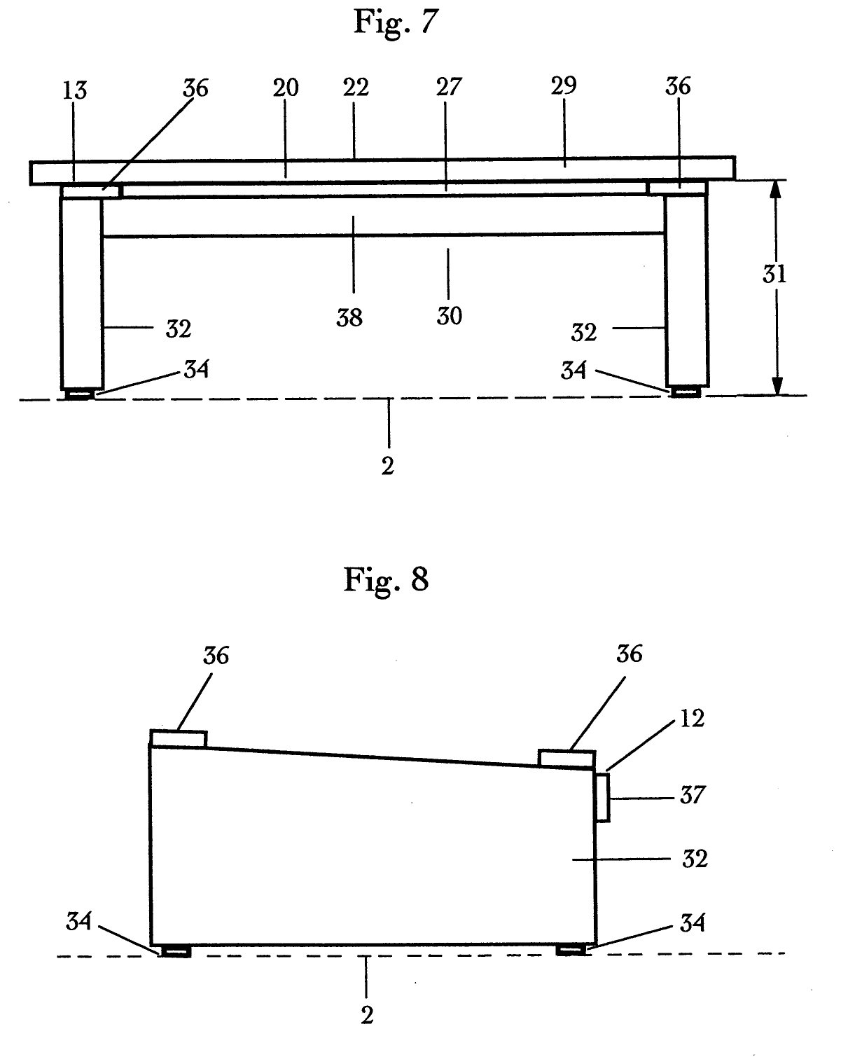

FIG. 6 is an overhead view of another embodiment of stand 30 of the cutting board and receptacle assembly 10. Stand 30 includes web members 33 which support legs 32 (not shown) and are interconnected by lateral web member 38. Stand 30 includes connection means 13 which are shown as raised L-shaped guide-members 36 which receive a lower portion 27 of platform 20 (shown in dashed lines and in FIG. 7).

Stand 30 includes sleeves 37 which are cylindrical members or members having another shape including a cavity for receiving arms of receptacle frame 59 for mounting receptacle frame 40 to stand 30. Sleeves 37 are shown as open, though they may be closed at an end. Also depicted is a bag roll holder 56 which may be fixed to stand 30 to hold additional bags for use.

FIG. 7 is a front view of the platform 20 and stand 30 of FIG. 6. Stand 30 supports platform 20 at a height 31 above work surface 2. Stand 30 includes legs 32 which have anti-slip surfaces 34 for contact with work surface 2. Lateral web member 38 connects the rear legs or rear portions of legs 32. Raised-guide members 36 are shown receiving lower portion 27 of platform 20. Upper portion 29 of platform 20 is not received within guide-members 36 but rests on guide-members 36 and extends beyond the profile of stand 30.

FIG. 8 is a side view of stand 30 of FIGS. 6 and 7, except that web members 33 (shown in FIG. 6) are not necessary or can be considered to be a part of legs 32 since legs 32 extend substantially from the front to the rear of platform 20. Only two side legs 32 are necessary to support platform 20 as in FIGS. 1 and 2. As shown, the rear portions of legs 32 are shorter than front portions of legs 32 to allow a platform positioned on stand 30 to drain to the rear, into receptacle 50. Platform and stand connection means 13 includes raised guide-members 36. Frame mounting means 12 are shown at the rear of stand 30. Bag roll holder 56 is not shown in this Figure.

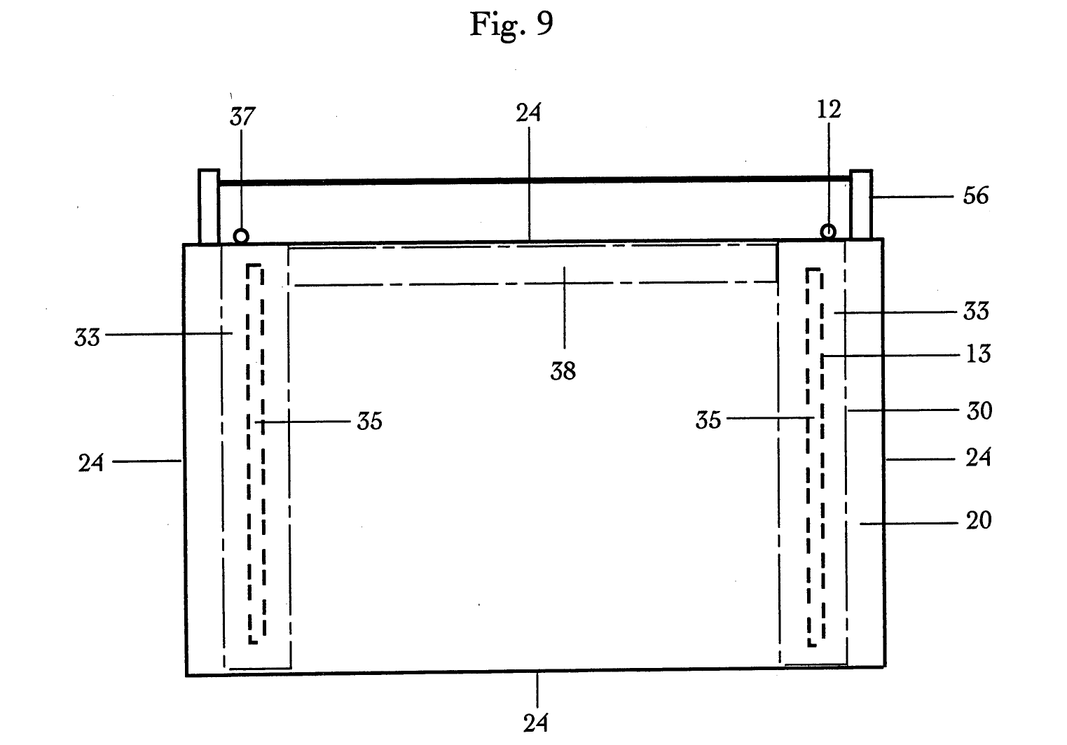

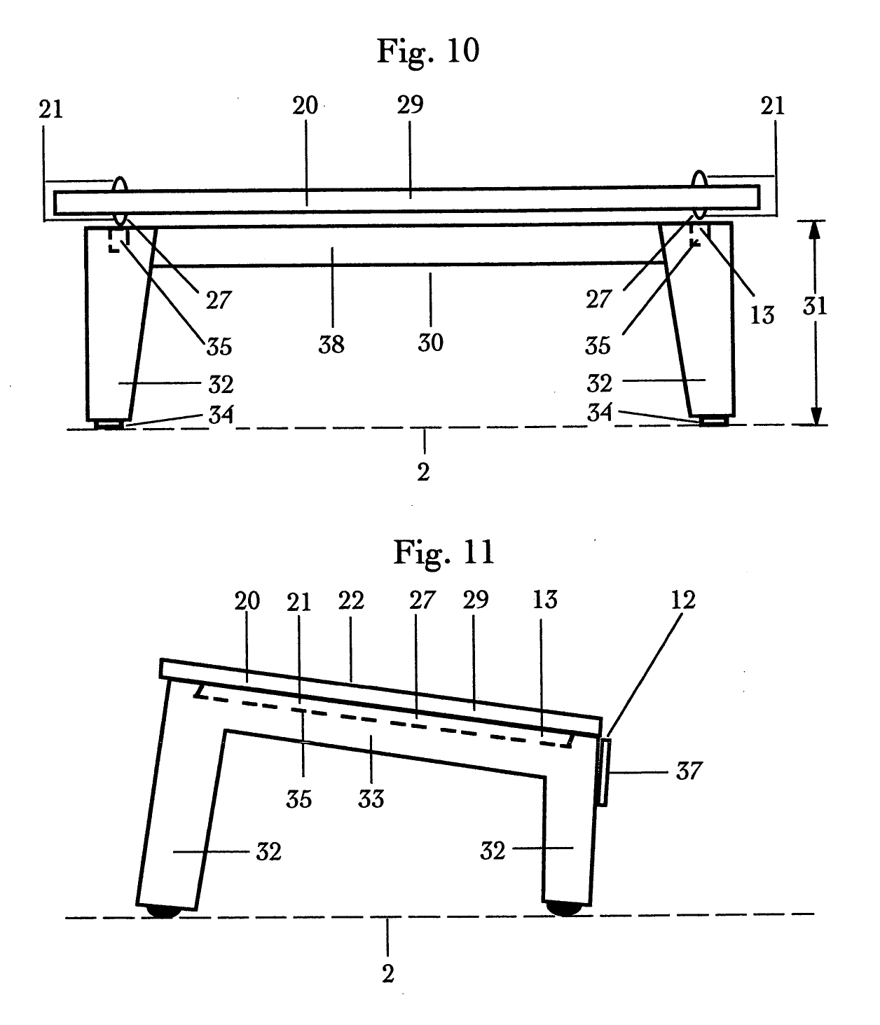

FIG. 9 is an overhead view of another embodiment of stand 30 of the cutting board and receptacle assembly 10. Stand 30 includes web members 33 which support legs 32 (not shown) and are interconnected by lateral web member 38. Stand 30 includes connection means 13 which are shown as elongated bores 35 which may be referred to as grooves. These grooves 35 receive a lower portion 27 of platform 20 (shown in FIG. 10).

Stand 30 includes sleeves 37 which are cylindrical members for receiving arms of receptacle frame 59 for mounting receptacle frame 40 to stand 30. Sleeves 37 are shown as open, though they may be closed. Also depicted is a bag roll holder 56 which may be fixed to stand 30 to hold additional bags for use.

FIG. 10 is a front view of the platform 20 and stand 30 of FIG. 9 with platform 20 spaced above stand 30 to facilitate understanding. Stand 30 supports platform 20 at a height 31 above work surface 2. Stand 30 includes legs 32 which have anti-slip surfaces 34 for contact with work surface 2. Lateral web member 38 connects the rear legs or rear portions of legs 32. Elongated bores or grooves 35 receive lower portions 27 of platform 20, in this case elongated posts 21 referred to as ribs. Upper portion 29 of platform 20 rests above grooves 35 and extends beyond the profile of stand 30. Grooves 35 and ribs 21 serve as the connection means 13 for connecting platform 20 to stand 30.

FIG. 11 is a side view of platform 20 and stand 30 of FIGS. 9 and 10 and shows platform 20 and stand 30 in connection. As shown, rear legs 32 are shorter than front legs 32 to allow a platform positioned on stand 30 to drain to the rear, into receptacle 50. Web members 33 interconnect front and rear legs 32. Platform and stand connection means 13 includes interconnecting grooves 35 and ribs 21. Frame mounting means 12 are shown at the rear of stand 30. Bag roll holder 56 is not shown in this Figure.

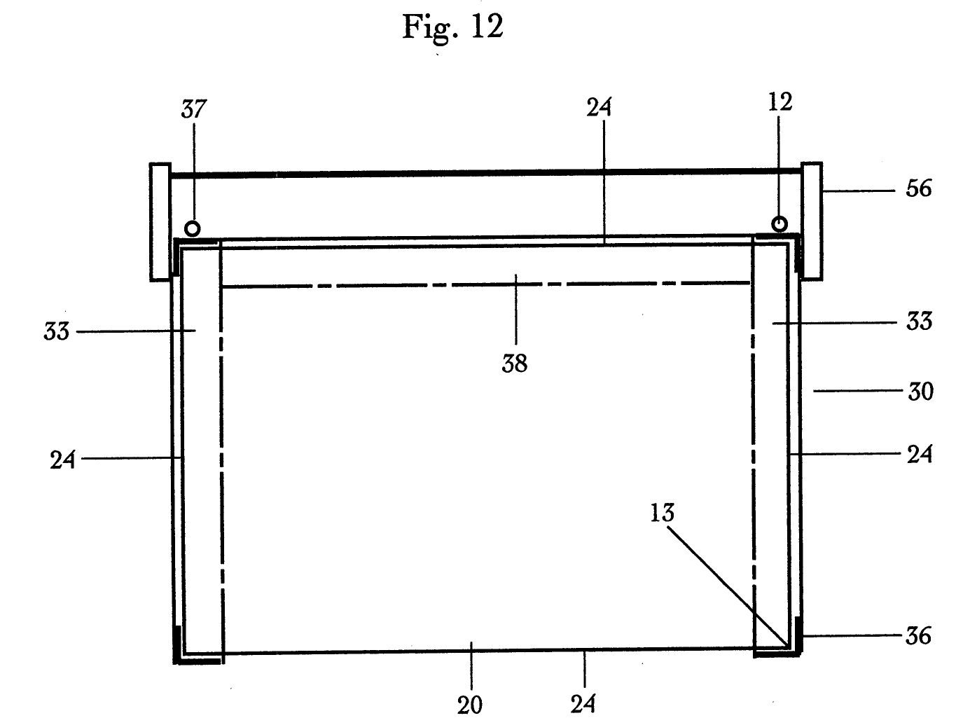

FIG. 12 is an overhead view of another embodiment of stand 30 of the cutting board and receptacle assembly 10. Stand 30 includes web members 33 which support legs 32 (not shown) and are interconnected by lateral web member 38. Stand 30 includes connection means 13 which are shown as raised guide-members 36 which receive platform 20 therebetween.

Stand 30 includes sleeves 37 which are cylindrical members for receiving arms of receptacle frame 59 for mounting receptacle frame 40 to stand 30. Sleeves 37 are shown as open, though they may be closed. Also depicted is a bag roll holder 56 which may be fixed to stand 30 to hold additional bags for use.

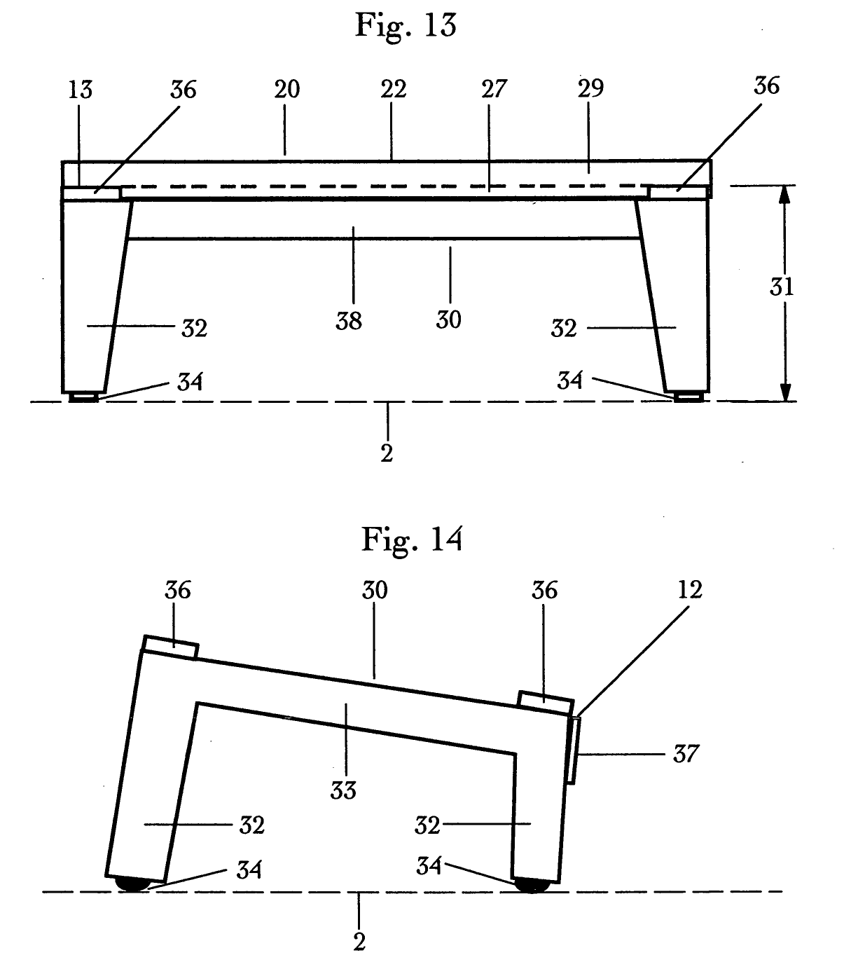

FIG. 13 is a front view of the platform 20 and stand 30 of FIG. 12. Stand 30 supports platform 20 at a height 31 above work surface 2. Stand 30 includes legs 32 which have anti-slip surfaces 34 for contact with work surface 2. Lateral web member 38 connects the rear legs or rear portions of legs 32. Raised guide-members 36 receive lower portion 27 of platform 20 therebetween to serve as connection means 13 and prevent unintended movement between platform 20 and stand 30. Upper portion 29 of platform 20 lies above raised guide-members 36.

FIG. 14 is a side view of stand 30 of FIGS. 9 and 10. As shown, rear legs 32 are shorter than front legs 32 to allow a platform positioned on stand 30 to drain to the rear, into receptacle 50. Web members 33 interconnect front and rear legs 32. Platform and stand connection means 13 includes guide-members 36 interacting with the edges 24 of platform 20. Frame mounting means 12 are shown at the rear of stand 30. Bag roll holder 56 is not shown in this Figure.

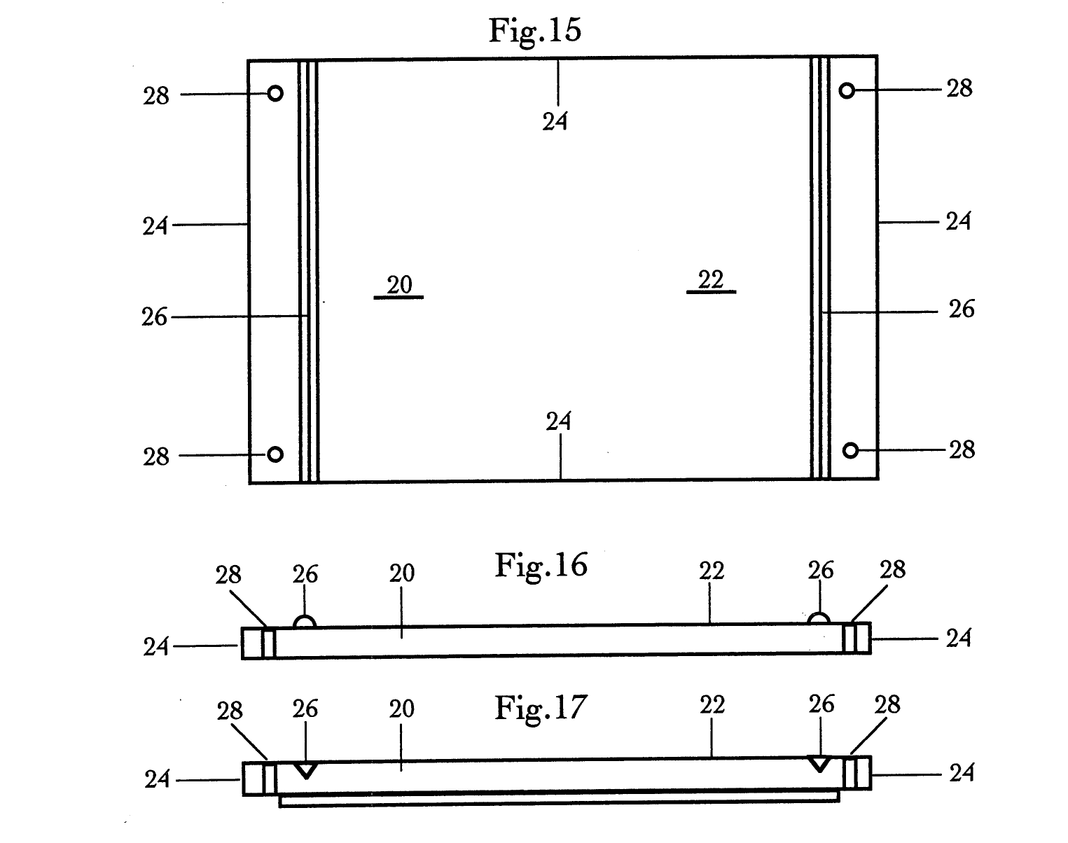

FIG. 15 is an overhead view of an alternate platform 20. Platform 20 includes a channel 26 extending from the front edge 24 to the rear edge 24. Platform 20 also includes apertures 28 which serve as mounting means 13 to mount receptacle frame 40 to platform 20.

FIG. 16 is a front view of an alternate platform 20. Platform 20 includes a raised channel 26 which extends up from processing surface 22 to prevent liquid from draining off of the sides of platform 20. Instead liquid is directed to the rear edge of processing surface 22, preferably into receptacle 50.

FIG. 17 is a front view of an alternate platform 20. Platform 20 includes an indented channel 26 which extends into processing surface 22 to prevent liquid from draining off of the sides of platform 20. Instead liquid travels through channel 26 to the rear edge of processing surface 22, preferably into receptacle 50.

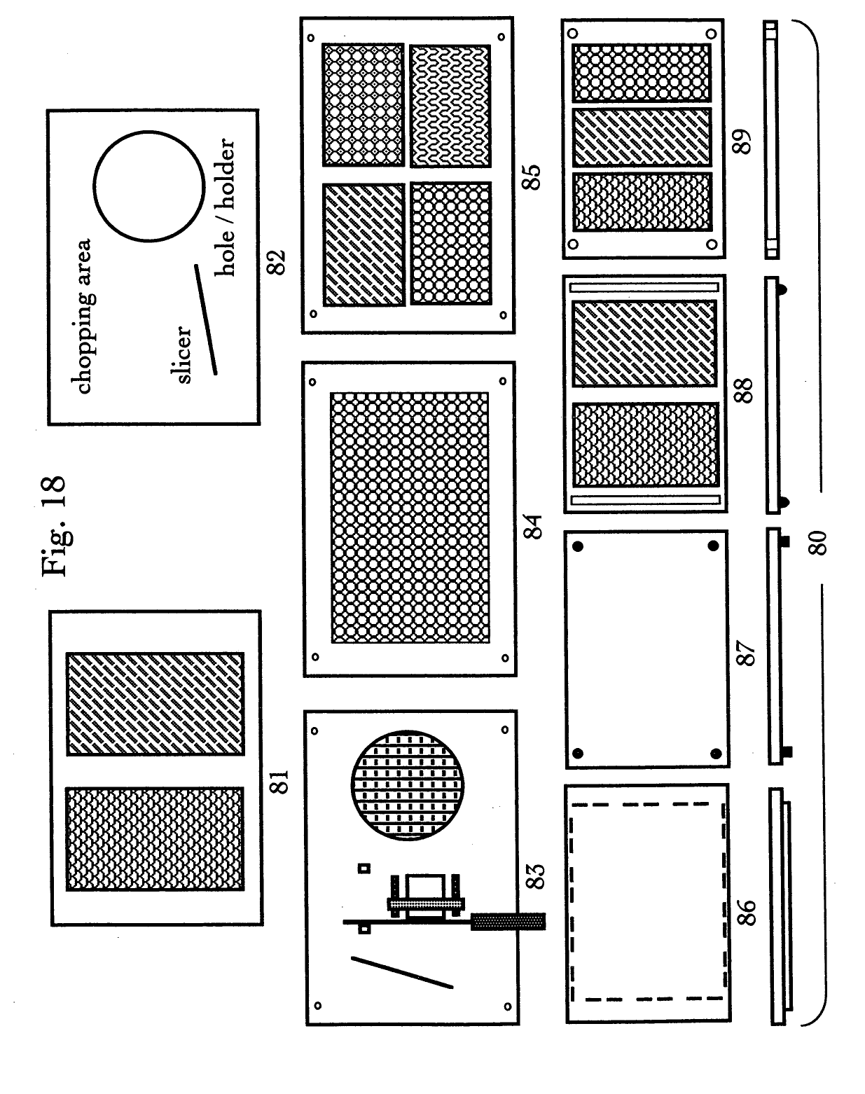

FIG. 18 is an overhead view of a plurality of platforms 80. As shown, plurality 80 includes platforms of various designs for use during different material processing, including food preparation, methods. As shown, the plurality of platforms 80 utilize different connection means 13. Preferably, a kit 14 (shown in FIG. 1) includes a plurality of platforms 80 with identical mounting means 12 and connection means 13, a corresponding stand 30, and a corresponding receptacle frame 40. The front view of platforms 86,87,88,89 show four different connection means. Platform 86 connects with stand 20 of FIGS. 6-8. Platform 87 connects with stand 20 of FIGS. 3-5. Platform 88 connects with stand 20 of FIGS. 9-11. Platforms 83,84,85,89 connect with stand 20 of FIGS. 3-5 or 9-11. Platforms 81 and 82 connect with stand 20 of FIGS. 12-14.

As shown, plurality of platforms 80 includes a platform including only a flat cutting surface, a platform including a grater, a platform including a slicer; a platform including a fish scaling surface; a platform including a grid cutter; and platforms including a combination of at least two of a flat cutting surface, a grater, a slicer, a fish scaling surface, and a grid cutter.

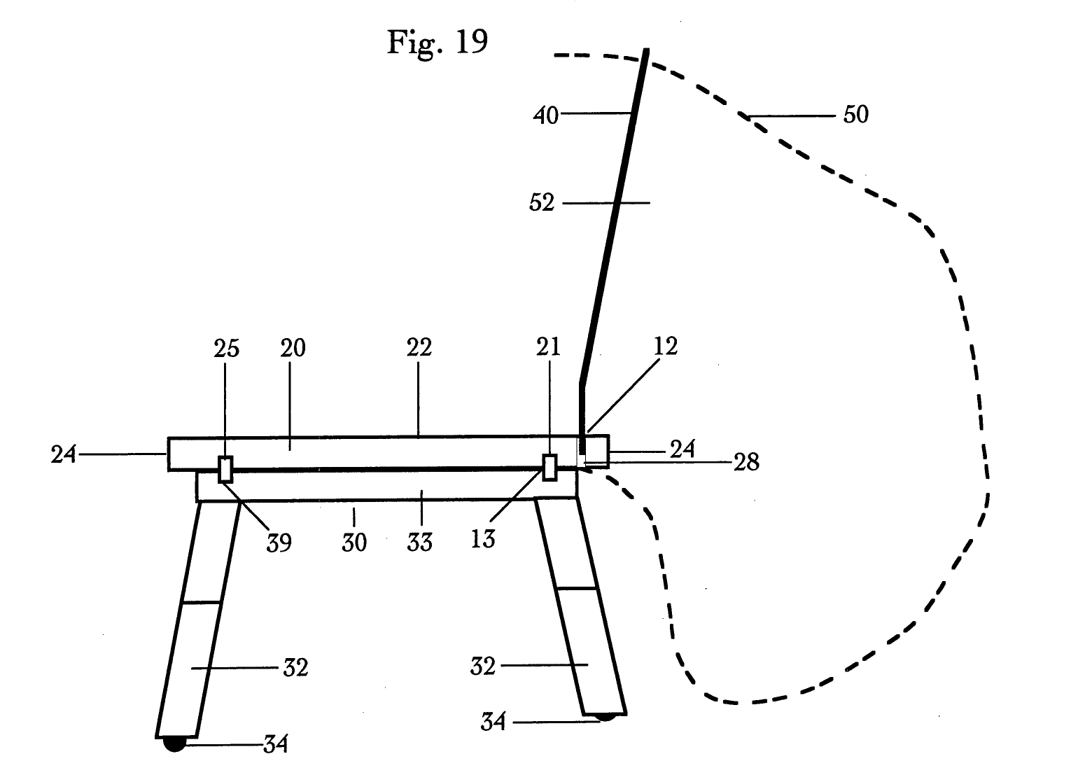

FIG. 19 is a side view of assembly 10 in which platform 20 includes holes 25 similar to those shown in platforms 83,84,85,89. Holes 25 may pass through platform 20 so that either surface of platform 20 can be used as processing surface 22. As shown in FIG. 19, holes 25 do not pass completely through platform 20. Stand 30 includes openings 39 which are aligned with holes 25. Posts 21, which may be independent elements, integral with platform 20, or integral with stand 30, rest in holes 25 and openings 39 to serve as connection means 13 between platform 20 and stand 30.

FIG. 19 also depicts adjustable-length legs 32. Such legs 32 may be adjusted to allow the angle of processing surface 22 to be controlled with respect to work surface 2. For instance, the rear legs 32 may be shortened or front legs lengthened 32 to allow liquid waste 9 to stream off of the back edge 24 of processing surface into receptacle 50. In FIG. 19, such adjustability is allowed by extending or contracting the anti-slip surfaces 34 with respect to legs 32.

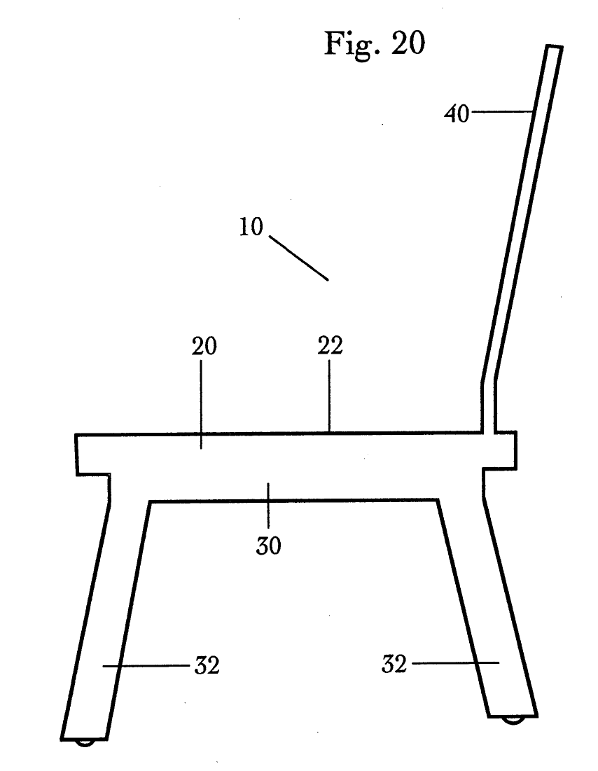

FIG. 20 is a side view of an assembly 10 in which the platform 20, stand 30, and receptacle frame 40 are integral with one another. Such an assembly 10 may be formed of any type of rigid plastic, wood, or other material suitable for material processing such as food preparation and convenient to clean and store.

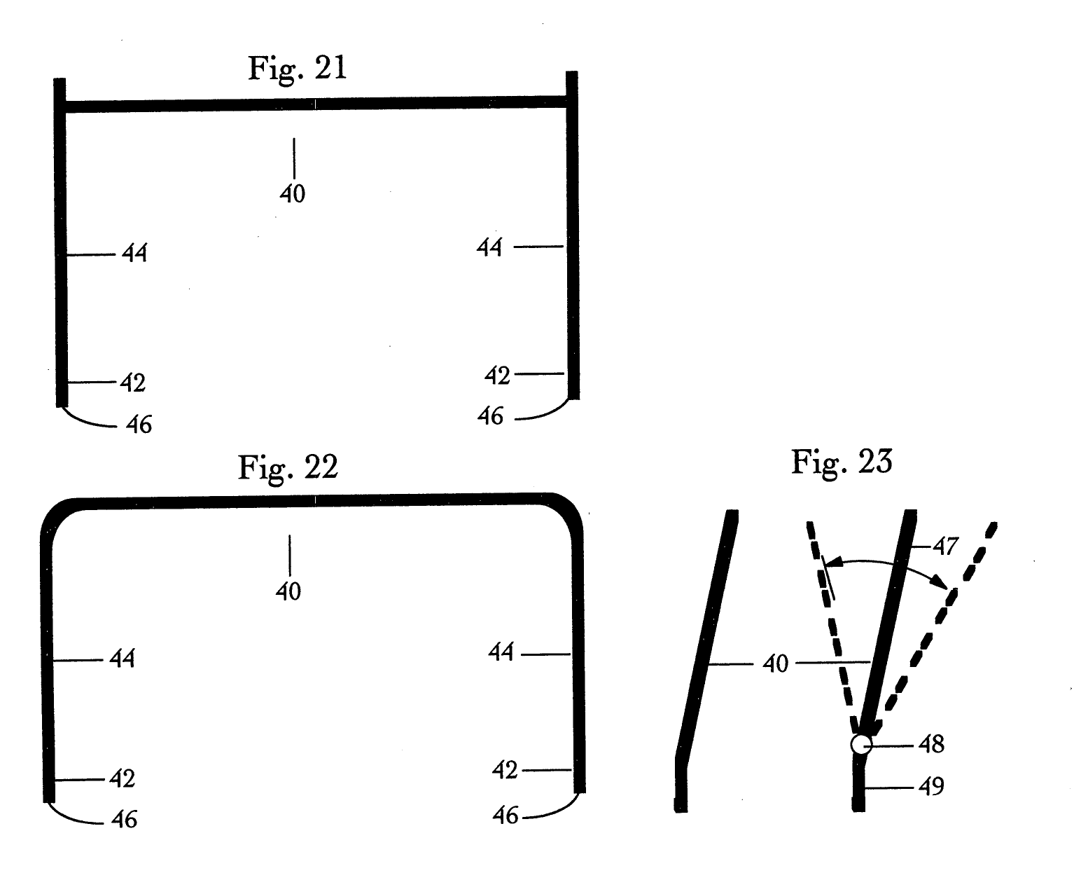

FIGS. 21 and 22 are front views of alternate receptacle frames 40. Each frame 40 includes a central portion between two arms 44 which terminate at ends 46. The arm portions 42 near ends 46 can be received in sleeves 37 or apertures 28 in stand 30 or platform 20 depending on the arrangement of the assembly 10. In FIG. 21, receptacle 50 is pierced by the free ends of arms 44 to hold receptacle 50 in place (such an arrangement is also shown in FIG. 19). In FIG. 22, receptacle 50 is fitted snugly around the top portion of frame 40 and is held in place by friction with frame and the lower surface of platform 20.

FIG. 23 is a side view of two alternate receptacle frames 40. Frame 40 on the left of FIG. 23 is rigid and substantially vertical. The other frame 40 includes a pivot 48 about which first portion 47 may be pivoted. Second portion 49 of frame 40 remains fixed with respect to the rest of assembly 10 during pivoting of first portion 47.

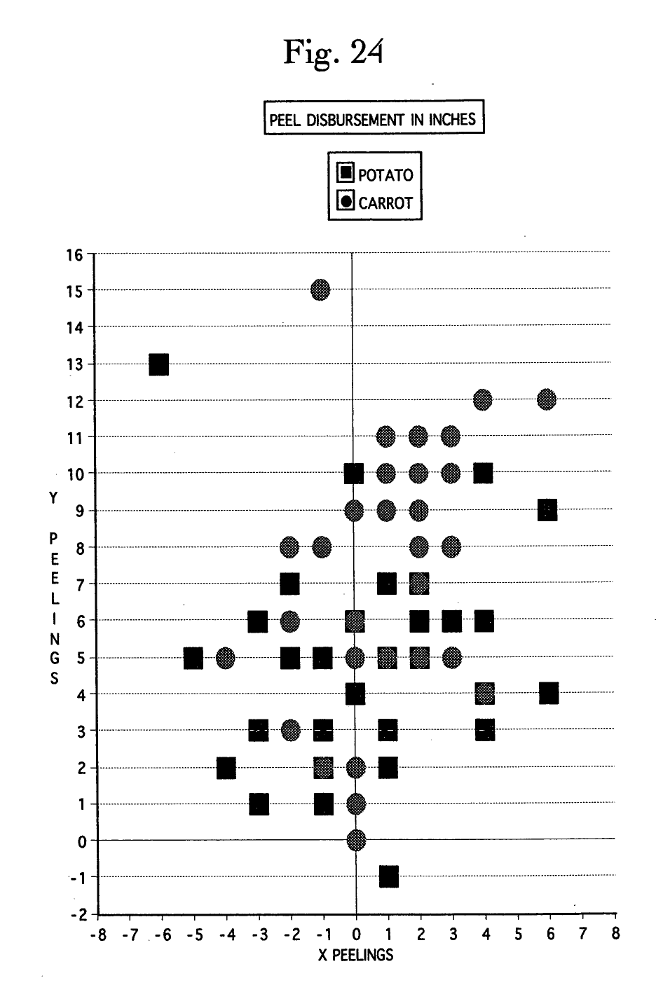

FIG. 24 includes data showing the location of peeled waste portions from a potato and a carrot. As can be seen, typical peeling of such vegetables results in a wide pattern of waste on work surface 2. By utilizing the assembly 10 of the invention, such waste can be contained and easily discarded.

Thus, it should be apparent that there has been provided, in accordance with the present invention a cutting board and receptacle assembly for use during material processing, such as food preparation, above a work surface that fully satisfies the objectives and advantages set forth above.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A cutting board and receptacle assembly for use during material processing above a work surface, the assembly comprising:
a rigid platform having a processing surface;
a stand for holding the platform above the work surface at a height allowing a container resting on the work surface to be positioned below the platform to receive processed material; and
a receptacle frame connected with respect to platform and/or stand, the receptacle frame supporting a receptacle for receiving waste, the receptacle having an opening which is substantially vertical when the receptacle is supported by the receptacle frame.

2. The assembly of claim 1 wherein the stand is adjustable to allow the platform to be held at an adjustable angle with respect to the work surface.

3. The assembly of claim 1 wherein the stand includes legs having anti-slip surfaces for contact with the work surface.

4. The assembly of claim 1 wherein the platform is bounded by edges, the platform including at least one channel adjacent the processing surface and extending to an edge to allow liquid to drain from the platform.

5. The assembly of claim 1 wherein the platform includes at least one aperture, the aperture receiving a portion of the receptacle frame to hold the receptacle frame at a fixed position with respect to the platform.

6. The assembly of claim 1 wherein the receptacle frame includes two arms, each arm terminating at an end, each end received within and supported by the platform.

7. The assembly of claim 1 wherein the receptacle frame includes a pivot separating a first portion from a second portion, the first portion being pivotable about the pivot with respect to the platform.

8. The assembly of claim 1 wherein the platform and stand are unitary.

9. The assembly of claim 1 further comprising connection means for connecting the platform and stand.

10. The assembly of claim 1 wherein the receptacle is a flexible bag, the bag resting on the work surface when the opening is supported by the receptacle frame.

11. The assembly of claim 1 wherein the platform includes at least one aperture, the aperture receiving a portion of the receptacle frame to hold the receptacle frame at a fixed position with respect to the platform.

12. The assembly of claim 1 wherein the platform includes a lower portion and the stand includes raised guide-members, the lower portion fitting within the guide-members.

13. The assembly of claim 12 wherein the platform includes an upper portion, the upper portion positioned above the guide-members when the lower portion is received within the guide-members.

14. A cutting board and receptacle assembly for use during material processing above a work surface, the assembly comprising:
a rigid platform having a processing surface;
a stand for holding the platform above the work surface at a height allowing a container resting on the work surface to be positioned below the platform to receive processed material, the platform attachable to and removable from the stand; and
a receptacle frame connected with respect to platform and/or stand for supporting a bag having an opening for receiving waste such that the opening is substantially vertical when the bag is supported by the receptacle frame and accepts waste from the processing surface, the opening surrounding the frame and the platform.

15. A kit for use during material processing above a work surface, the kit comprising:
a plurality of platforms having processing surfaces;
a stand for holding one platform at a time above the work surface at a height allowing a container to be positioned on the work surface below the platform to receive processed material; and
a receptacle frame connected with respect to platform and/or stand, the receptacle frame supporting a receptacle for receiving waste, the receptacle having an opening which is substantially vertical when the receptacle is supported by the receptacle frame.

16. The kit of claim 15 wherein each of the plurality of platforms includes identical means for connection to the stand such that the platforms are interchangeable.

17. The kit of claim 16 wherein each of the plurality of platforms includes a first and second edge and apertures spaced from the first and second edge such that each of the plurality of platforms may be connected to the stand regardless of orientation.

18. The kit of claim 16 wherein the plurality of platforms comprises:
a platform including only a flat cutting surface;
a platform including a grater;
a platform including a slicer;
a platform including a fish scaling surface;
a platform including a grid cutter; or
a platform including a combination of at least two of a flat cutting surface, a grater, a slicer, a fish scaling surface, and a grid cutter.

19. The kit of claim 18 wherein each of the plurality of platforms includes identical mounting means for mounting the receptacle frame.

20. The kit of claim 18 wherein the stand includes means for mounting the receptacle frame.
